(19) United States
(12) Patent Application Publication
(10) Pub. No.: US 2018/0001509 A1
(43) Pub. Date: Jan. 4, 2018

(54) METHOD AND DEVICE FOR INSERTING A TONGUE

(71) Applicant: Välinge Innovation AB, Viken (SE)

(72) Inventors: Fredrik MYLLYKANGAS, Uddevalla (SE); Jonas FRANSSON, Allerum (SE)

(73) Assignee: Välinge Innovation AB, Viken (SE)

(21) Appl. No.: 15/635,379

(22) Filed: Jun. 28, 2017

(30) Foreign Application Priority Data
Jun. 29, 2016 (SE) 16509408

(51) Int. Cl. B27F 1/12; B27G 13/08; B27G 13/00

(52) U.S. Cl. CPC B27F 1/12; B27G 13/005; B27G 13/08

(57) ABSTRACT

A method and device for managing and separating a tongue from a tongue blank, including cutting a first edge of a tongue from the tongue blank by rotating a tool which includes a protruding part, and displacing the tongue by the protruding part to a tongue queue. The method and device may include a second tool for cutting a second edge of the tongue from the tongue blank.

### CROSS REFERENCE TO RELATED APPLICATIONS

The present application claims the benefit of Swedish Application No. 1650940-8, filed on Jun. 29, 2016. The entire contents of Swedish Application No. 1650940-8 are hereby incorporated herein by reference in their entirety.

### FIELD OF THE INVENTION

Embodiments of the present invention relate to methods and devices for inserting a tongue into an insertion groove in a panel. The panel is configured to be arranged and locked perpendicular to an adjacent panel by a locking device comprising the tongue. The panels may be assembled and locked together to obtain a furniture product, such as a bookshelf, a cupboard, a wardrobe, a box, a drawer or a furniture component.

### BACKGROUND OF THE INVENTION

A conventional furniture product may be assembled by a plurality of elements or panels. The panels may be assembled with a mechanical locking device, such as disclosed in, for example, WO 2012/154113 A1. The product comprises a first panel connected perpendicularly to a second panel by a mechanical locking device comprising, an edge tongue at the first panel, an edge groove at the second panel and a flexible tongue in an insertion groove.

WO 2015/038059 discloses a product assembled by a plurality of panels that are locked by mechanical locking devices comprising a flexible tongue in an insertion groove.

The locking devices of the panels are generally produced in a production line by a continuous production process, comprising a number of milling tools. The edge groove and the insertion groove may extend contiguously from a front edge to a back edge of the panel. The edge groove is preferably covered at the front edge by a decorative layer. The edge groove and the insertion groove may also end before the front edge and/or the back edge as disclosed in, e.g., SE 1650135-5.

Embodiments of the present invention address a need to provide an improved method and an improved device for separating a tongue from a tongue blank before inserting the tongue into an insertion groove in a panel.

### SUMMARY OF THE INVENTION

Accordingly, embodiments of the present invention preferably seek to mitigate, alleviate or eliminate one or more deficiencies, disadvantages or issues in the art, such as the above-identified, singly or in any combination by providing a method for managing and separating a tongue from a tongue blank.

A further object of embodiments of the invention is to provide a device for managing and separating a tongue from a tongue blank.

At least some of these and other objects and advantages that will be apparent from the description have been achieved by a first aspect of the invention comprising a method for managing and separating a tongue from a tongue blank, comprising cutting a first edge of a tongue from a tongue blank by rotating a tool, which comprises a protruding part, and displacing the tongue by the protruding part to a tongue queue. Managing and separating the tongue by a rotating tool may have the advantage that one and the same tool may be used for separating and displacing the tongue, and the time for separating and displacing the tongue may be decreased.

The cutting may comprise cutting the first edge between said rotating tool and a dye.

The method may comprise rotating the tool by a shaft, wherein the shaft comprises a rotating disc, and guiding the tongue by the rotating disc during the cutting. The disc may have the same shape as the rotating tool.

The method may comprise cutting a second edge of the tongue from the tongue blank by a second of said rotating tool.

The method may comprise compressing said tongue by the protruding part. A compression force, obtained by said compressing, may be utilized for displacing the tongue in the tongue queue.

The method may comprise compressing one or more of said tongue, positioned in the tongue queue, by the protruding part.

The method may comprise displacing the tongue by the protruding part, during the cutting, from an upper inlet to a lower outlet.

A second aspect of the invention comprises a device for managing and separating a tongue from a tongue blank, wherein the device comprises a rotatable tool with a curve shaped outer edge with a protruding part, wherein the curve shaped edge is configured to cut a first edge of the tongue from the tongue blank, and wherein the protruding part is configured to displace the tongue from a cutting position.

The tongue queue preferably comprises two or more tongues which are preferably identical or essentially identical to said tongue.

The device may comprise a dye at the cutting position, wherein the first edge is cut between the dye and the curved edge.

A radius, of a cutting segment of the curve shaped outer edge, may be increasing along the cutting segment.

The device may comprise a second of said rotatable tool configured to cut a second edge of the tongue from the tongue blank.

The device may comprise a shaft and the rotatable tool may be attached to the shaft, wherein the device further comprises a rotatable disc, which may be attached to the shaft and configured to guide the tongue during the cutting.

The device may comprise a second of said rotatable tool, which is attached to the shaft, configured to cut a second edge of the tongue from the tongue blank, wherein the rotatable disc is attached to the shaft between the rotatable tool and said second rotatable tool.

The device may comprise an upper inlet at a first side of the cutting position and a lower outlet at a second side of the cutting position, wherein the protruding part is configured to displace the tongue from the upper inlet to the lower outlet.

The device may comprise a blocking device, which is positioned between the upper inlet and the lower outlet, configured to prevent the tongue from being displaced from the lower outlet towards the upper inlet.

The protruding part may be configured to compress the tongue in the outlet.

The tongue according to the first and/or second aspect may comprise one or more of the features below:

The tongue may be of an elongated shape and may comprise a first long edge and a second long edge. The first edge may be a first short edge, and the second edge may be an opposite second short edge.

A longitudinal direction of the tongue is preferably parallel to an axis of rotation of the rotatable/rotating tool.

The tongue may be a flexible tongue and made of, e.g., a polymer and preferably comprising a reinforcement material, such as a fibre, e.g., fiberglass.

The tongue may comprise a bendable part at the first long edge and preferably a groove adjacent the bendable part. The bendable part may be configured to be pushed into the groove adjacent the bendable part. The tongue may comprise several of said bendable part and preferably several of said groove.

The tongue may comprise a polymer material and is preferably produced by injection moulding.

The tongue may be connected to several tongues in the tongue blank by a first rail at the first short edge and preferably by a second rail at the second short edge.

The first rail and the second rail may extend in a length direction perpendicular to the tongue.

The tongue may be connected to the first rail and/or the second rail, which may be casting gates, by a first and a second casting gate, respectively

The tongue is preferably configured to be displaceable in the insertion groove.

The device is preferably a part of a production line comprising milling tools for forming a locking device at the edge of the panel. The locking device preferably comprises said insertion groove.

The edge groove and the insertion groove may extend contiguously from a front edge to a back edge of the panel.

### BRIEF DESCRIPTION OF THE DRAWINGS

These and other aspects, features and advantages of which embodiments of the invention are capable of, will be apparent and elucidated from the following description of embodiments of the present invention, reference being made to the accompanying drawings, in which

FIGS. 1A-1D show a method for managing and separating a tongue from a tongue blank according to an embodiment of the invention.

FIGS. 2A-2B show a device according to an embodiment of the invention.

FIGS. 3A-3D show embodiments of the tongue according to embodiments of the invention.

FIGS. 4A-4D show an embodiment of the tongue according to an embodiment of the invention.

FIGS. 5A-5D show embodiments of the panel according to embodiments of the invention.

### DESCRIPTION OF EMBODIMENTS

Specific embodiments of the invention will now be described with reference to the accompanying drawings. This invention may, however, be embodied in many different forms and should not be construed as limited to the embodiments set forth herein; rather, these embodiments are provided so that this disclosure will be thorough and complete, and will fully convey the scope of the invention to those skilled in the art. The terminology used in the detailed description of the embodiments illustrated in the accompanying drawings is not intended to be limiting of the invention. In the drawings, like numbers refer to like elements.

Embodiments are shown that may improve managing and separating efficiency of a tongue from a tongue blank.

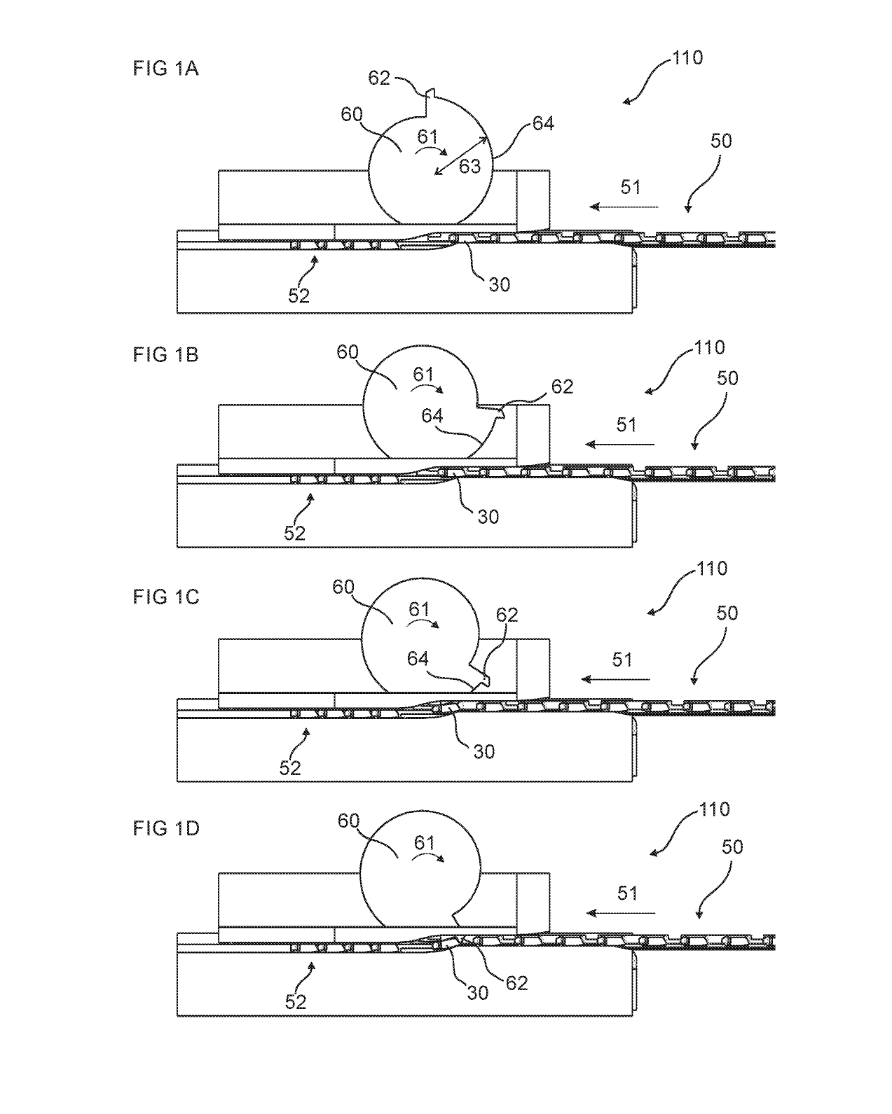

An embodiment of the method and a device 110 is shown in a side view in FIGS. 1A-1D from a starting position in FIG. 1A, with a protruding part 62 of a tool 60 facing upwards, to a position of contact between the protruding part 62 and a tongue 30 in FIG. 1D. The method comprises a method for managing and separating a tongue from a tongue blank, comprising cutting a first edge 34 of a tongue 30 from a tongue blank 50 by rotating 61 a tool 60 which comprises a protruding part 62, and displacing the tongue 30 by the protruding part 62 to a tongue queue 52. The tongue queue preferably comprises two or more tongues which are preferably identical or essentially identical to said tongue.

The tongue blank 50 is displaced in a feeding direction 51 towards the tool until a tongue of the tongue blank has reached a cutting position in the device 110.

A rail of the tongue blank 50 may have a length direction parallel to the feeding direction 51.

A longitudinal direction of the tongue 30, at the time of feeding and separation from the tongue blank, is preferably parallel to an axis of rotation of the rotatable/rotating tool 60.

The device may comprise a dye 76 and the tongue is cut between the tool and the dye. The tongue 30 is preferably displaced by means of the protruding part 62 when the tongue 30 is separated or almost separated from the tongue blank 50.

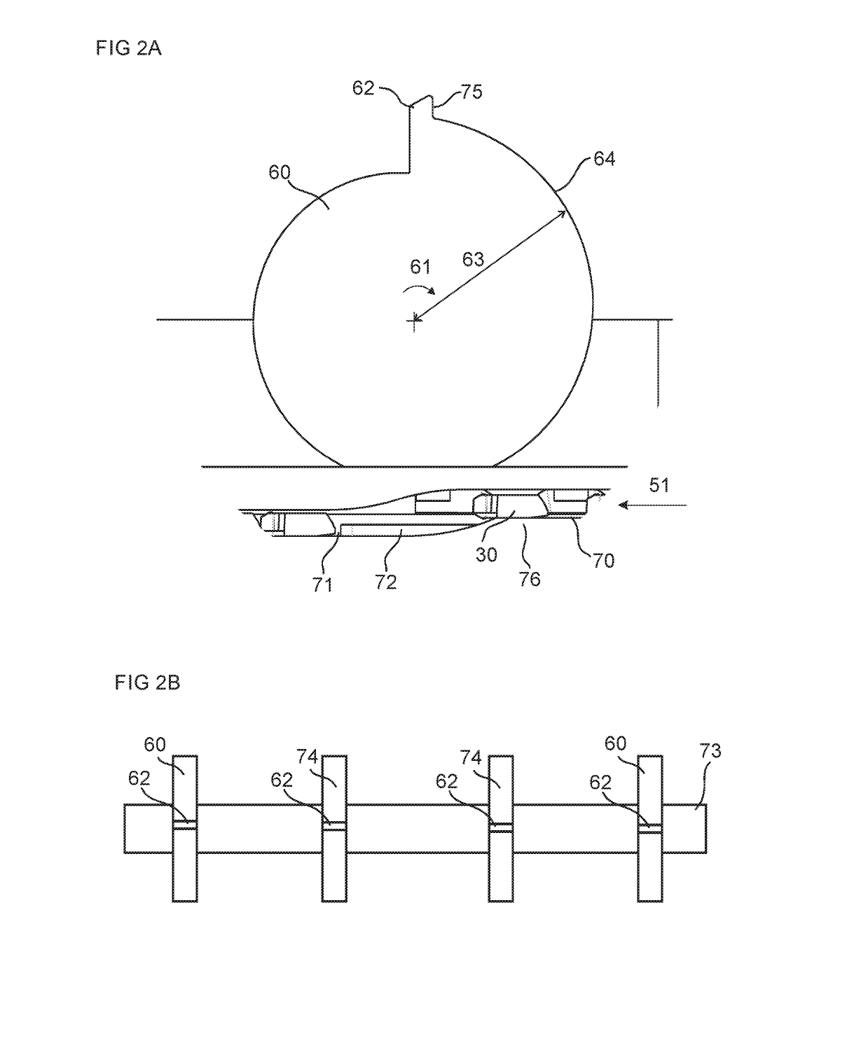

The method may comprise rotating the tool 60 by a shaft 73, see FIG. 2B, wherein the shaft comprises a rotating disc 74, and guiding the tongue 30 by the rotating disc during the cutting. The disc 74 may have the same shape as the tool, and the device may comprise a free space under the disc, such that the tongue is guided and displaced without cutting the tongue apart.

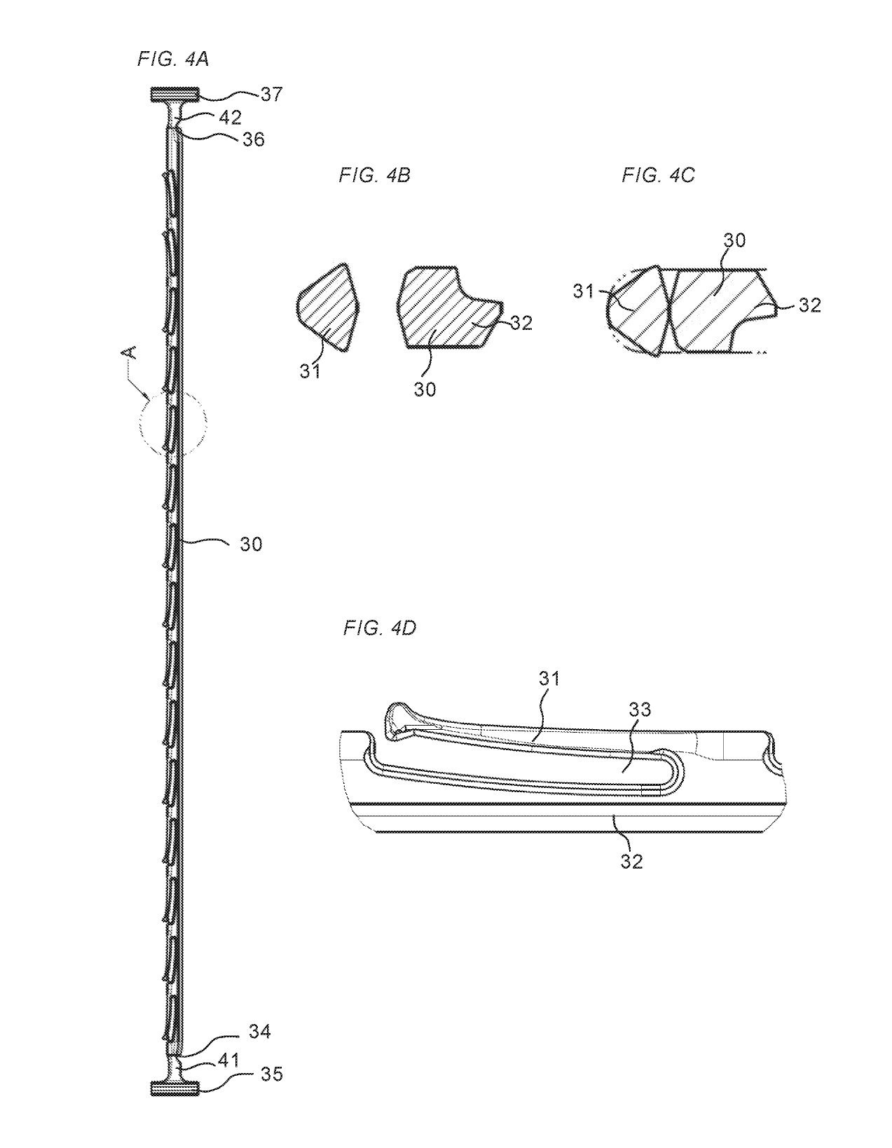

The method preferably comprises cutting a second edge 36 of the tongue 30 from the tongue blank 50 by a second of said rotating tool 60, see FIG. 4A.

The method may comprise compressing said tongue 30 by the protruding part 62.

The method may comprise compressing the tongues in the tongue queue 52, by the protruding part 62.

The method may comprise displacing the tongue by the protruding part 62, during the cutting, from an upper inlet 70 to a lower outlet 71.

The method preferably comprises further rotating the tool 60 in the same direction 61 from the contact position in FIG. 1D (not shown) until the tool has reached the starting position in FIG. 1A.

FIG. 2A shows an enlargement of an area surrounding the tool 60 of the embodiment of the device 110, which is shown in FIG. 1A-1D. The device comprises a rotatable tool 60 with a curve shaped outer edge 64 with a protruding part 62, wherein the curve shaped edge 64 is configured to cut a first edge 34 of the tongue 30 from the tongue blank 50, and wherein the protruding part 62 is configured to displace the tongue 62 from a cutting position by means of a face 75.

A radius 63, of a cutting segment of the curve shaped outer edge 64, is increasing along the cutting segment. The cutting segment may be 45-180° of the arc of the tool, preferably 60-120° of the arc. The cutting segment may have a radius 63 that is longer than a radius of the remainder of tool (excepting the protruding part 62). The device may comprise a second of said rotatable tool 60 configured to cut a second edge 36 of the tongue from the tongue blank 50.

The device may comprise a shaft 73, see FIG. 2B, and the rotatable tool 60 may be attached to the shaft 73, wherein the device may further comprise a rotatable disc 74, which is attached to the shaft 73 and configured to guide the tongue 30 during the cut.

Embodiments of the tongue 30 may have a longitudinal length in the range of about 30 mm to about 300 mm. Embodiments of the device for tongues with a longitudinal length in a lower part of the range may not comprise the rotatable disc 74.

The device may comprise a second of said rotatable tool 60, which may be attached to the shaft 73, configured to cut a second edge 36 of the tongue 30 from the tongue blank 50, wherein the rotatable disc 74 is preferably attached to the shaft 73 between the rotatable tool 60 and said second rotatable tool 60. The embodiment shown in FIG. 2B comprises said rotatable tool 60 attached to a first end of the shaft and a second of said rotatable tool 60 attached to a second end of the shaft and two of said rotatable disc 74, attached to the shaft between the rotatable tool and the second of said rotatable tool. The rotatable disc may have the same shape as the rotatable tool and comprise the protruding part 62.

The device may comprise an upper inlet 70 at a first side of the cutting position and a lower outlet 71 at a second side of the cutting position, wherein the protruding part 62 is configured to displace the tongue 30 from the upper inlet 70 to the lower outlet 71.

The device may comprise a blocking device 72, which is positioned between the upper inlet 70 and the lower outlet 71, configured to prevent the tongue from being displaced from the lower outlet 71 towards the upper inlet 70, by a compression force of compressed tongues in the tongue queue.

The protruding part 62 may be configured to compress the tongue 30 in the outlet 71.

The device may comprise a measuring device for determining the number of tongues in the tongue queue by measuring, e.g., the compression degree of the tongues. When the number of tongues in the tongue queue is to low the rotatable tool will feed another of said tongue into the tongue queue. The tongues in the tongue queue may be displaced by compression forces from the tongues in the tongue queue. A desired displacement of the tongues in the tongue queue may depend on the number of tongues in the tongue queue.

The measuring device may be an optical measuring device which may measure light transmission through the tongue queue. When the number of tongues in the tongue queue is low, the light transmission is high. An embodiment of the measuring device may measure the force from the compressed tongues in the tongue queue. A further embodiment of the measuring device may count the number of tongues that are fed into the tongue queue and the number of tongues that are fed out from the tongue queue.

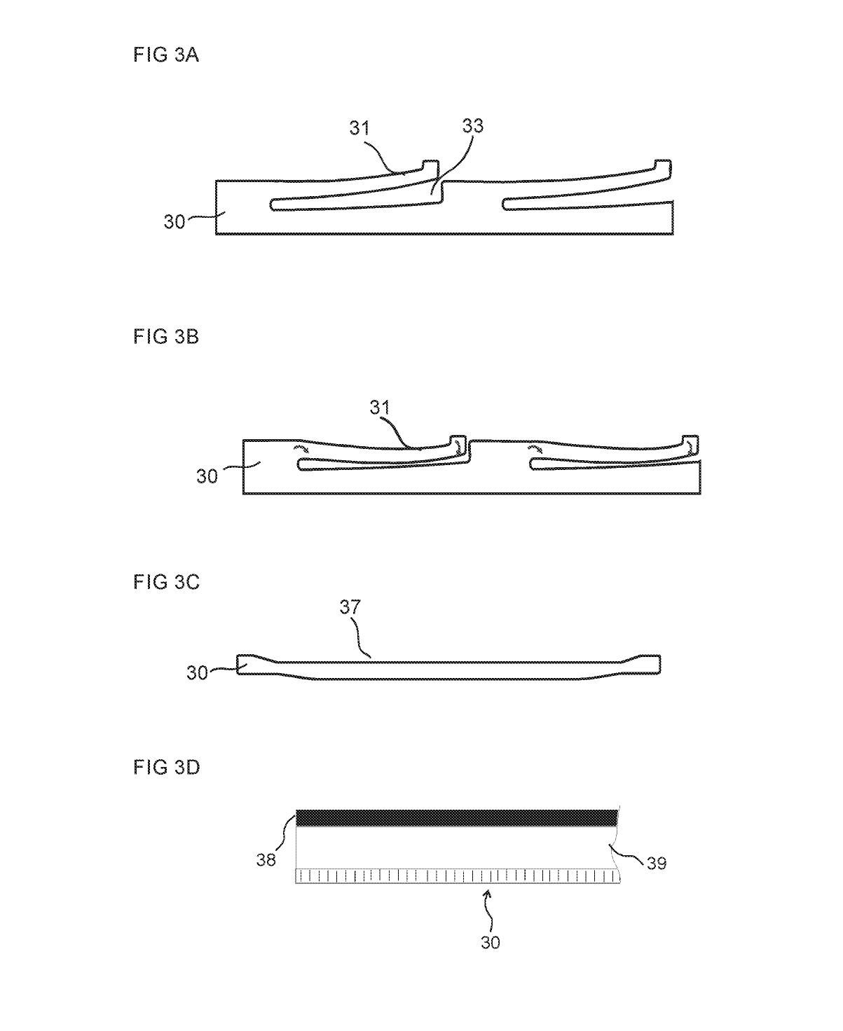

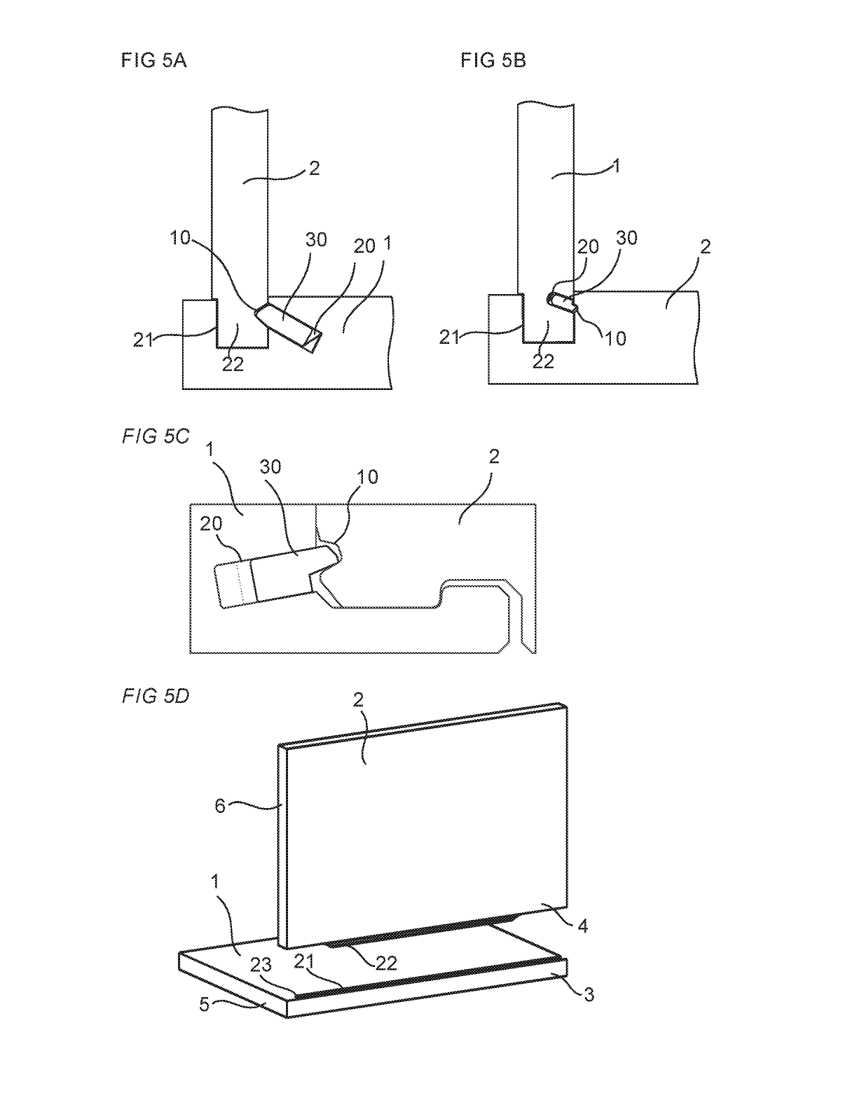

Embodiments of the tongue 30, which may be displaceable in an insertion groove 20, see FIGS. 5A-5D, are shown in FIGS. 3A-D. A first embodiment of the tongue, which is shown in FIG. 3A-3B, comprises bendable protruding parts 31 at a first long edge of the tongue. The first embodiment is shown in a relaxed state in FIG. 3A and in a compressed state in FIG. 3B. A second long edge of the tongue is preferably essentially straight. The first embodiment may be inserted into the insertion groove with the bendable protruding parts facing towards a bottom of the insertion groove and the second edge extending beyond an opening of the insertion groove. A second embodiment of the tongue, which is shown in FIG. 3C in a relaxed state, is of an elongated shape and flexible. The second embodiment comprises a recess 37 at a first long edge of the tongue and a second edge which is essentially straight. The recess is decreased in a compressed state of the second embodiment. The second embodiment may be inserted into the insertion groove with the recess 37 facing towards a bottom of the insertion groove and the second edge extending beyond an opening of the insertion groove. A third embodiment of the tongue, which is shown in FIG. 3D, comprises a first part 38, which is flexible and configured to be compressed, and a second part 39 which is rigid. The first part may be arranged in the insertion groove and the second part may partly extend beyond an opening of the insertion groove.

The tongue may be configured as any of the embodiments of the displaceable tongue disclosed in, e.g., WO 2006/043893 and WO 2007/015669, the entire contents of which are hereby expressly incorporated herein by reference.

The tongue may be flexible and made of, e.g., a polymer and preferably comprising a reinforcement material, such as a fibre, e.g., fiberglass.

Another embodiment of the tongue 30 is shown in FIGS. 4A-D. The tongue is of an elongated shape and comprises a first short edge 34, an opposite second short edge 36, first long edge and a second long edge 32. FIG. 4D shows an enlargement of the encircled area A indicated in FIG. 4A. The tongue comprises several bendable parts 31 at the first long edge and a groove 33 at each bendable part 31. The tongue comprises a polymer material and is preferably produced by injection moulding. The bendable part 31 is configured to be pushed into the groove 33 in a compressed state of the tongue.

FIG. 4A shows an embodiment of tongue which is connected to several tongues (not shown) in a tongue blank by a first rail 35 at the first short edge 34 and by a second rail 37 at the second short edge 36. The first rail and the second rail extend in a length direction perpendicular to the tongue. In an embodiment, the rotatable tool 60 cuts the tongue 30 free from the first rail 35 and a second rotatable tool 60 cut the tongue 30 from the second rail 37. The tongue may be connected to the first rail and/or the second rail, which may be casting gates, by a first and a second casting gate 41,42, respectively.

FIG. 4B and FIG. 4C show the tongue 30 in a cross cut view. The tongue is in FIG. 4B in a relaxed state an in FIG. 4C in a compressed state. A distance between an outer part of the bendable part 31 and the second long edge 32 is shorter in the compressed state compared to in the relaxed state.

The tongue is preferably configured to be inserted into an insertion groove of a panel for locking the panel to an adjacent panel.

FIGS. 5A-5D shows embodiments of the panel 1, each comprising an embodiment of the tongue 30 inserted in an embodiment of the insertion groove 20, connected to an adjacent panel 2. The embodiments of the panel shown in FIGS. 5A-5D may be furniture panels. The embodiment of the panel shown in FIG. 5C may also be a floor panel.

FIG. 5A shows the panel 1 arranged perpendicular to an adjacent panel 2 and locked to the adjacent panel in a first direction and in a second direction, which is perpendicular to the first direction. The panel comprising an edge groove 21 at an upper surface of the panel. The edge groove 21 is of a longitudinal shape and extends along an edge of the panel 1. The edge groove comprising said insertion groove 20, which is extending along the edge groove, comprising said tongue 30. The adjacent panel comprises an edge tongue 22 which comprises a tongue groove 10 extending along an edge of the adjacent panel. The tongue 30 is configured to cooperate with the tongue groove 10 for locking together the panel 1 with the adjacent panel 2 in the first direction. The edge tongue 22 is configured to cooperate with the edge groove 21 for locking together the panel 1 with the adjacent panel 2 in the second direction.

FIG. 5B shows the panel 1 arranged perpendicular to an adjacent panel 2 and locked to the adjacent panel in a first direction and in a second direction, which is perpendicular to the first direction. The adjacent panel comprising an edge groove 21 at an upper surface of the adjacent panel. The edge groove 21 is of a longitudinal shape and extends along an edge of the adjacent panel 1. The edge groove comprises a tongue groove 10. The panel comprises an edge tongue 22 which comprises said insertion groove 20 comprising said tongue 30. The insertion groove is extending along the edge tongue. The tongue 30 is configured to cooperate with the tongue groove 10 for locking together the panel 1 with the adjacent panel 2 in the first direction. The edge tongue 22 is configured to cooperate with the edge groove 21 for locking together the panel 1 with the adjacent panel 2 in the second direction.

FIG. 5C shows the panel 1 arranged parallel to an adjacent panel 2 and locked to the adjacent panel in a first direction and in a second direction, which is perpendicular to the first direction. The panel comprising said insertion groove 20 which is extending along an edge of the panel. The edge comprises a strip protruding from the edge and the strip comprises an upwardly protruding locking element. The adjacent panel 2 comprises a tongue groove 10 extending along an adjacent edge of the adjacent panel 2. The adjacent edge comprises a locking groove with an opening facing downwards. The tongue 30 is configured to cooperate with the tongue groove 10 for locking the panel to the adjacent panel in a first direction and the locking element is configured to cooperate with the locking groove for locking the panel to the adjacent panel in the second direction. An embodiment of the said first and second panel comprises the insertion groove 20 at the adjacent edge of the adjacent panel and the tongue groove 10 at the edge of the panel.

FIG. 5D shows an embodiment of the panel and the adjacent panel shown in FIG. 5A in a 3D-view. The edge tongue 22 is extending along the edge 4 of the adjacent panel and ends before an adjacent edge 6 of the adjacent panel 2. The edge groove 21 is extending along the edge 3 of the panel 1 and ends at a side wall 23 before an adjacent edge of the 5 of the panel 1.

A core material of embodiments of the panel and the adjacent panel described above may comprises a wood fibre based board, such as a HDF, MDF, plywood, solid wood or particleboard, or a reinforced plastic board or a wood fibre composite board. The core may be provided with a decorative layer.

### EMBODIMENTS

1. A method for managing and separating a tongue from a tongue blank, comprising cutting a first edge (34) of a tongue (30) from a tongue blank (50) by rotating (61) a tool (60) which comprises a protruding part (62), displacing the tongue (30) by the protruding part (62) to a tongue queue (52).

2. The method as in embodiment 1, wherein the method comprises rotating the tool (60) by a shaft (73), wherein the shaft comprises a rotating disc (74), and guiding the tongue (30) by the rotating disc (74) during the cutting.

3. The method as in embodiment 1 or 2, wherein the method comprises cutting a second edge (36) of the tongue (30) from the tongue blank (50) by a second of said rotating tool (60).

4. The method as in any one of the embodiments 1-3, wherein the method comprises compressing said tongue (30) by the protruding part (62).

5. The method as in any one of the embodiments 1-4, wherein the method comprises compressing one or more of said tongue, positioned in the tongue queue (52), by the protruding part (62).

6. The method as in any one of the embodiments 1-5, wherein the method comprises displacing the tongue by the protruding part (62), during the cutting, from an upper inlet (70) to a lower outlet (71).

7. A device for managing and separating a tongue from a tongue blank, wherein the device comprises a rotatable tool (60) with a curve shaped outer edge (64) with a protruding part (62), wherein the curve shaped edge (64) is configured to cut a first edge (34) of the tongue (30) from the tongue blank (50), and wherein the protruding part (62) is configured to displace the tongue (62) from a cutting position.

8. The device as in embodiment 7, wherein a radius (63), of a cutting segment of the curve shaped outer edge (64), is increasing along the cutting segment.

9. The device as in any one of embodiments 7-8, wherein the device comprises a second of said rotatable tool (60) configured to cut a second edge (36) of the tongue from the tongue blank (50).

10. The device as in any one of embodiments 7-9, wherein the device comprises a shaft (73) and the rotatable tool (60) is attached to the shaft (73), wherein the device further comprises a rotatable disc (74), which is attached to the shaft (73) and configured to guide the tongue (30) during the cutting.

11. The device as in embodiment 10, wherein the device comprises a second of said rotatable tool (60), which is attached to the shaft (73), configured to cut a second edge (36) of the tongue (30) from the tongue blank (50), wherein the rotatable disc (74) is attached to the shaft (73) between the rotatable tool (60) and said second rotatable tool (60).

12. The device as in any one of embodiments 7-11, wherein the device comprises an upper inlet (70) at a first side of the cutting position and a lower outlet (71) at a second side of the cutting position, wherein the protruding part (62) is configured to displace the tongue (30) from the upper inlet (70) to the lower outlet (71).

13. The device as in embodiment 12, wherein the device comprises a blocking device (72), which is positioned between the upper inlet (70) and the lower outlet (71), configured to prevent the tongue from being displaced from the lower outlet (71) towards the upper inlet (70).

14. The device as in embodiment 12 or 13, wherein the protruding part (62) is configured to compress the tongue (30) in the lower outlet (71).

1. A method for managing and separating a tongue from a tongue blank, comprising cutting a first edge of a tongue from a tongue blank by rotating a tool which comprises a protruding part, displacing the tongue by the protruding part to a tongue queue.

2. The method as claimed in claim 1, wherein the method comprises rotating the tool by a shaft, wherein the shaft comprises a rotating disc, and guiding the tongue by the rotating disc during the cutting.

3. The method as claimed in claim 1, wherein the method comprises cutting a second edge of the tongue from the tongue blank by a second of said rotating tool.

4. The method as claimed in claim 1, wherein the method comprises compressing said tongue by the protruding part.

5. The method as claimed in claim 1, wherein the method comprises compressing one or more of said tongue, positioned in the tongue queue, by the protruding part.

6. The method as claimed in claim 1, wherein the method comprises displacing the tongue by the protruding part, during the cutting, from an upper inlet to a lower outlet.

7. A device for managing and separating a tongue from a tongue blank, wherein the device comprises a rotatable tool with a curve shaped outer edge with a protruding part, wherein the curve shaped edge is configured to cut a first edge of the tongue from the tongue blank, and wherein the protruding part is configured to displace the tongue from a cutting position.

8. The device as claimed in claim 7, wherein a radius, of a cutting segment of the curve shaped outer edge, is increasing along the cutting segment.

9. The device as claimed in claim 7, wherein the device comprises a second of said rotatable tool configured to cut a second edge of the tongue from the tongue blank.

10. The device as claimed in claim 7, wherein the device comprises a shaft and the rotatable tool is attached to the shaft, wherein the device further comprises a rotatable disc, which is attached to the shaft and configured to guide the tongue during the cutting.

11. The device as claimed in claim 10, wherein the device comprises a second of said rotatable tool, which is attached to the shaft, configured to cut a second edge of the tongue from the tongue blank, wherein the rotatable disc is attached to the shaft between the rotatable tool and said second rotatable tool.

12. The device as claimed in claim 7, wherein the device comprises an upper inlet at a first side of the cutting position and a lower outlet at a second side of the cutting position, wherein the protruding part is configured to displace the tongue from the upper inlet to the lower outlet.

13. The device as claimed in claim 12, wherein the device comprises a blocking device, which is positioned between the upper inlet and the lower outlet, configured to prevent the tongue from being displaced from the lower outlet towards the upper inlet.

14. The device as claimed in claim 12, wherein the protruding part is configured to compress the tongue in the lower outlet.
